(19) United States
(12) Patent Application Publication
(10) Pub. No.: US 2023/0396801 A1
(43) Pub. Date: Dec. 7, 2023

(54) LEARNED VIDEO COMPRESSION FRAMEWORK FOR MULTIPLE MACHINE TASKS

(71) Applicant: VID SCALE, INC., Wilmington, DE (US)

(72) Inventors: Fabien RACAPE, San Francisco, CA (US); Lahiru Dulanjana HEWA GAMAGE, Davis, CA (US); Akshay PUSHPARAJA, San Jose, CA (US); Jean BEGAINT, Menlo Park, CA (US)

(21) Appl. No.: 18/033,693

(22) PCT Filed: Nov. 3, 2021
(86) PCT No.: PCT/US2021/057858

§ 371 Date: Apr. 25, 2023

Related U.S. Application Data
(60) Provisional application No. 63/109,486, filed on Nov. 4, 2020.

(51) Int. Cl. H04N 19/597; H04N 19/105; H04N 19/176; H04N 19/136; H04N 19/42

(52) U.S. Cl. CPC H04N 19/597; H04N 19/105; H04N 19/176; H04N 19/136; H04N 19/42

(57) ABSTRACT

Processing of a compressed representation of a video signal is optimized for multiple tasks, such as object detection, viewing of displayed video, or other machine tasks. In one embodiment, multiple analysis stages and a single synthesis is performed as part of a coding/decoding operation with training of an encoder side analysis and, optionally, a corresponding machine task. In another embodiment, multiple synthesis operations are performed on the decoding side, so that respective analysis, synthesis, and task stages are optimized. Other embodiments comprise feeding decoded feature maps to tasks, predictive coding, and using hyperprior-based models.

### TECHNICAL FIELD

At least one of the present embodiments generally relates to a method or an apparatus for video encoding or decoding, compression or decompression.

### BACKGROUND

To achieve high compression efficiency, image and video coding schemes usually employ prediction, including motion vector prediction, and transform to leverage spatial and temporal redundancy in the video content. Generally, intra or inter prediction is used to exploit the intra or inter frame correlation, then the differences between the original image and the predicted image, often denoted as prediction errors or prediction residuals, are transformed, quantized, and entropy coded. To reconstruct the video, the compressed data are decoded by inverse processes corresponding to the entropy coding, quantization, transform, and prediction.

### SUMMARY

At least one of the present embodiments generally relates to a method or an apparatus for image and video encoding or decoding, and more particularly, to a method or an apparatus for using template matching prediction in combination with other coding tools, as in the VVC (Versatile Video Coding or H.266) standard.

According to a first aspect, there is provided a method. The method comprises steps for generating a plurality of tensors of feature maps from multiple analyses of at least one image portion; and encoding said plurality of tensors into a bitstream.

According to a second aspect, there is provided another method. The method comprises steps for decoding a bitstream to generate multiple feature maps; and processing the multiple feature maps using at least one synthesizer to generate outputs for multiple tasks.

According to another aspect, there is provided an apparatus. The apparatus comprises a processor. The processor can be configured to execute any of the aforementioned methods.

According to another general aspect of at least one embodiment, there is provided a device comprising an apparatus according to any of the decoding embodiments; and at least one of (i) an antenna configured to receive a signal, the signal including the video block and tensors of feature maps, (ii) a band limiter configured to limit the received signal to a band of frequencies that includes the video block, or (iii) a display configured to display an output representative of a video block or any receiving device analyzing features/decoded content.

According to another general aspect of at least one embodiment, there is provided a non-transitory computer readable medium containing data content generated according to any of the described encoding embodiments or variants.

According to another general aspect of at least one embodiment, there is provided a signal comprising video data generated according to any of the described encoding embodiments or variants.

According to another general aspect of at least one embodiment, a bitstream is formatted to include data content generated according to any of the described encoding embodiments or variants.

According to another general aspect of at least one embodiment, there is provided a computer program product comprising instructions which, when the program is executed by a computer, cause the computer to carry out any of the described decoding embodiments or variants.

These and other aspects, features and advantages of the general aspects will become apparent from the following detailed description of exemplary embodiments, which is to be read in connection with the accompanying drawings.

### BRIEF DESCRIPTION OF THE DRAWINGS

FIG. 1 illustrates a basic auto-encoder chain.

FIG. 2 illustrates an example framework including an autoencoder for image/video compression, coupled with a machine task which is run on the decoded pictures.

FIG. 3 illustrates an example embodiment of a proposed framework for the aspects described.

FIG. 4 illustrates an example of a proposed framework with multiple decoder synthesis models.

FIG. 5 illustrates a proposed framework where decoded tensors are directly fed to task algorithms.

FIG. 6 illustrates one flow diagram of an embodiment of an encoder under the general aspects described.

FIG. 7 illustrates one flow diagram of an embodiment of a decoder under the general aspects described.

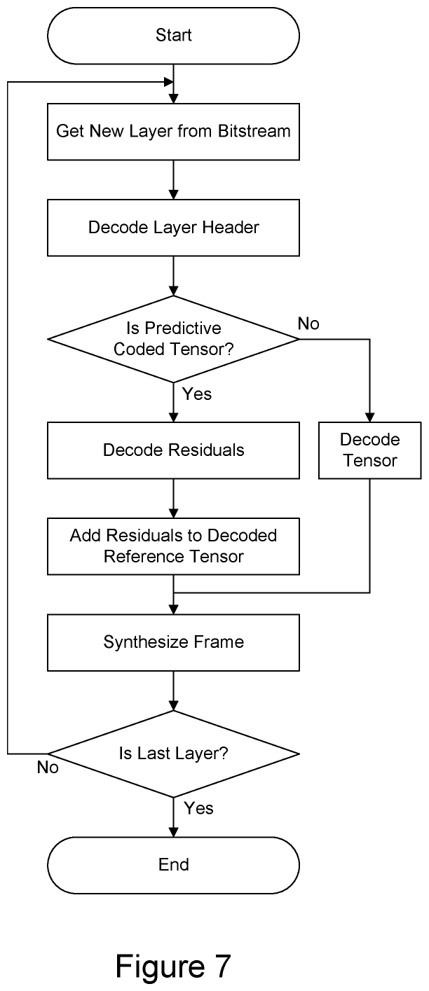

FIG. 8 illustrates an example autoencoder with scale (and mean) hyperprior.

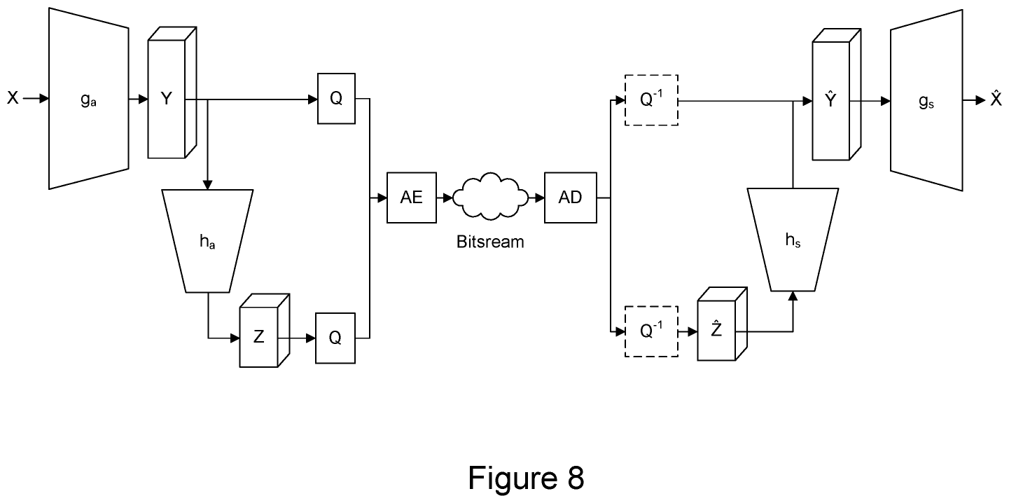

FIG. 9 shows one embodiment of a method under the general described aspects.

FIG. 10 shows another embodiment of a method under the general described aspects.

FIG. 11 shows an example apparatus under the described aspects.

FIG. 12 shows a standard, generic video compression scheme.

FIG. 13 shows a standard, generic video decompression scheme.

FIG. 14 shows a processor based system for encoding/decoding under the general described aspects.

### DETAILED DESCRIPTION

The embodiments described here are in the field of video compression and decompression and video encoding and decoding generally and more specifically in the context of the compression of images and videos for machine tasks, also called video coding for machines. The proposed methods can apply to images and videos. In the following, the term “video” is used and can be interchanged by “image” as images represent a subset of a video content.

In the domain of video transmission, traditional compression standards can reach low bitrates by transforming and degrading the videos based on signal fidelity or visual quality. However, an increasing number of videos is now “viewed” by machines rather than humans, by typically involving algorithms based on neural networks. Optimizing existing video encoders directly for machine consumption is not trivial because of their handcrafted coding tools.

A new standardization group at ISO/MPEG is studying the evidence of the need of a standard for transmitting/storing bitstreams which contain the necessary information for performing different tasks at the receiver, such as segmentation, detection, object tracking, etc.

In recent years, novel image and video compression methods based on neural networks have been developed. These methods are also called end-to-end deep-learning-based methods. The parameters of the model transforming and encoding the input content and reconstructing it are fully trainable. The neural networks parameters are learned during training based on the minimization of a loss function. In a compression case, the loss function describes both an estimation of the bitrate of the encoded bitstream, and the targeted task. Traditionally the quality of the reconstructed image is optimized, for example based on the measure of the signal distortion or an approximation of the human-perceived visual quality. For machine-based tasks, the distortion term can be modified to integrate the accuracy of a given machine task (or any measure of a task performance) on the reconstructed output.

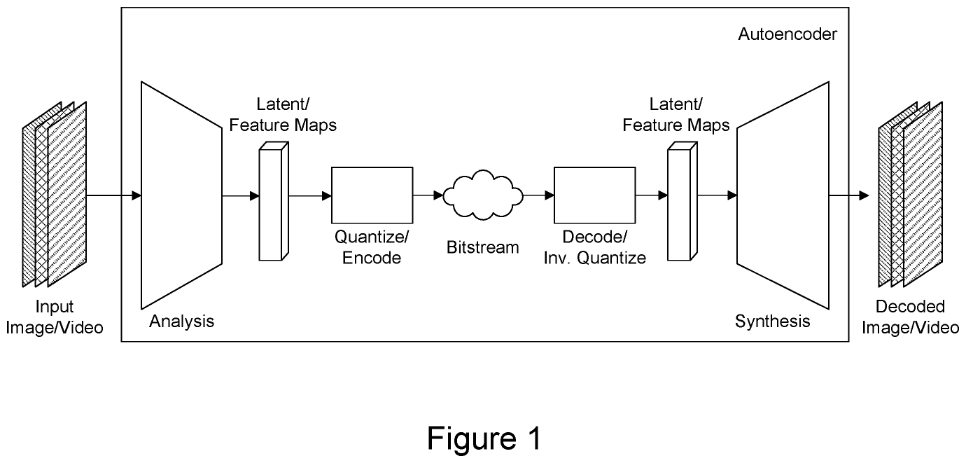

FIG. 1 shows an auto-encoder (AE) based end-to-end compression. Autoencoders are a form of neural networks popular for compression applications. The input to the encoder part of the network, i.e. the set of operations to the left of bitstream in FIG. 1, can consist of:
an image or frame of a video,
a part of an image
a tensor representing a group of images
a tensor representing a part (crop) of a group of images.
A set of multiple images or groups of images captured by different cameras/sensors.

In each case, the input can have one or multiple components, e.g.: monochrome, RGB or YCbCr components.
The encoder network is usually composed of a set of convolutional layers with stride, allowing to reduce the spatial resolution of the input while increasing the depth, i.e. the number of channels of the input. Squeeze operations can also be used instead of stride convolutional layers (space-to-depth via reshaping and permutations). The encoder network can be seen as a learned transform.
The output of the analysis, which consists of a tensor sometimes referred to as latent or feature maps in the following, is then quantized, and entropy coded. At training, a so-called “spatial-bottleneck” which reduces the number of values in the latent or an “entropy-bottleneck” to simulate the entropy coding module are used to allow compression of the original data. The bitstream, i.e. the set of coded syntax elements and payloads of bins representing the quantized symbols, is transmitted to the decoder.
The decoder, after entropy decoding the quantized symbol from the bitstream, feeds the decoded latent tensor to a set of layers usually composed of (de) convolutional layers (or depth-to-space squeeze operations) to synthesize the output frames. The decoder network is thus a learned inverse transform operating on quantized coefficients.
The output of the decoder is the reconstructed image or a group of images.

Note that some more sophisticated layouts exist, for example adding an “hyper-autoencoder” (hyper-prior) to the network in order to jointly learn the latent distribution properties of the encoder output.

In current approaches, such DNN-based AEs can be trained using several types of losses:
Loss targeting high video quality for human viewing:
   “objective” metrics, typically Mean Squared Error (MSE) or based on structural similarity (SSIM). The results may not be perceptually as good as the second type, but the fidelity to the original signal (image) is higher.
   “subjective” metrics (or subjective by proxy), typically using Generative Adversarial Networks (GANs) during the training stage or advanced visual metric via a learned neural network proxy.
Loss targeting high accuracy for machine tasks. In that case, the algorithm used for the machine task is used, jointly with the auto-encoder to provide a final task output such as an object bounding box, the classification of objects or their tracking over the frames of videos.

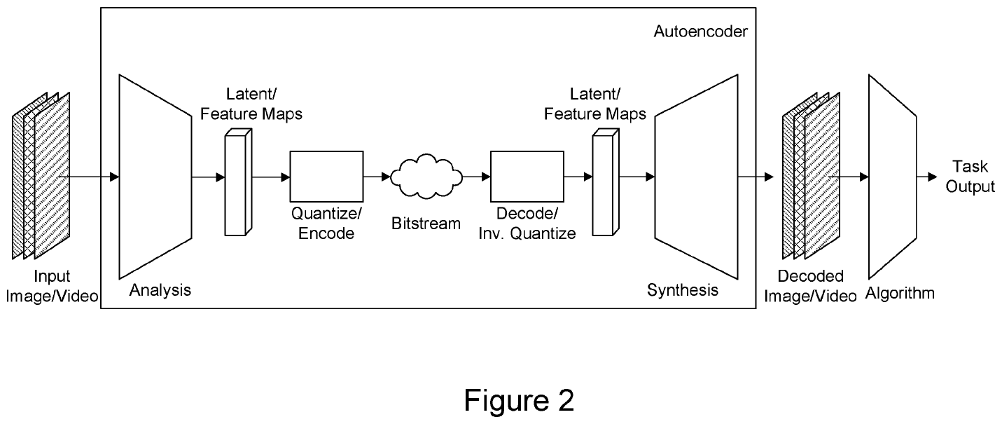

The latter case can rely on a framework as shown in FIG. 2. The advantage of using a learnable auto-encoder instead of a traditional codec is that the parameters of both the autoencoder and the algorithm can be optimized with respect to specific tasks. If the graph of the task algorithm is known, the gradients at each training step can be backpropagated from the measured accuracy to the analysis part of the AE. Without backpropagation the neural network cannot be trained.

The described embodiments aim at solving the problem of optimizing a standard compressed representation of a video signal for multiple tasks.

Traditional video compression standards cannot be optimized for specific machine tasks as they contain non-differentiable handcrafted operations. On the other hand, state-of-the-art learned approaches for image/video compression can be trained or fine-tuned for specific tasks. It could be envisioned to include multiple tasks in a training loss to find a compromise AE network which produces outputs that work well with multiple tasks. However, the produced decoded content remains suboptimal for each specific task. Auto-encoders coupled with machine task algorithms can be trained and fine-tuned for each specific task. The described embodiments propose a method which enables to have a standard bitstream for interoperability between sensors and analysis devices. Like in scalable video coding the compressed information can be decomposed in a base representation and enhancement information which can be decoded for increasing the accuracy of specific machine tasks.

Having a generic, and standardizable, decoder is a critical component for the adoption of a compression scheme by the industry, and the standards.

Machine tasks such as object detection, image classification, segmentation, etc. are usually trained on large datasets of images/videos that are already compressed using traditional codecs.

Current end-to-end compression networks usually train a unique network, either for an objective metric (typically MSE/PSNR), or using a perceptual metric, for visual consumption, rarely for specific tasks.

To our knowledge there is no methods enabling to embed compressed data in a bitstream that is optimized for multiple machine tasks, which is what is proposed in the described embodiments.

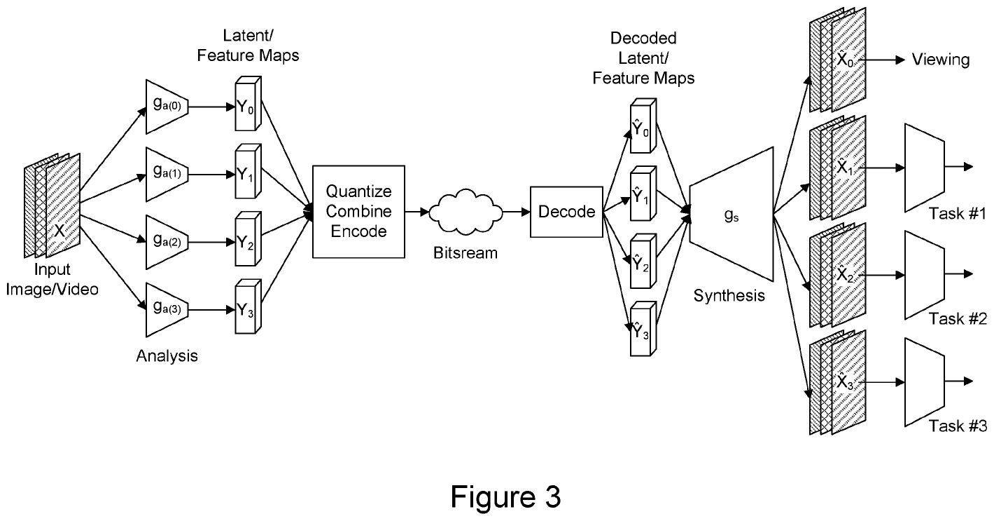

A basic exemplary implementation of the proposed embodiments consists of a framework containing an auto-encoder and multiple machine task algorithms, as depicted in FIG. 3 (all neural networks). In this scheme, the analysis step can be trained separately with respect to each specific task. In this exemplary framework, 3 tasks are considered, one model is used to produce images optimized for viewing, i.e. using high fidelity metrics or Human Visual System oriented metrics. Each analysis bloc generates a latent or feature maps. The encoder part has to be modified to take as input these four tensors. This part is described in the following sections.

In the example of FIG. 3, the decoder part {decoder+synthesis} contains only one model gₛ for generating the different image/video outputs \hat{X}ₗ from decoded feature maps Ŷᵢ. The idea is to create a framework where the decoder is generic and can be standardized. In that case, the parameters of the synthesis can be trained while optimizing the high fidelity of output frames from the source, or a compromise between several tasks. Then, for each task, the task algorithm as well as the encoder part (analysis) can be retrained or fine-tuned to optimize further for each given task.

The latent tensors can be combined in the bitstream like layers in the domain of scalable or multi-view video coding. In particular, they can be coded in differential, i.e. tensors can be predicted from already decoded tensors, and only the residuals are transmitted. The synthesis at decoding is the same for each decoded latent, producing different frames depending on the input decoded tensor.

For example, such system can include a base layer (base tensor) optimized for viewing, and additional tensors specialized for object detection and video segmentation.

The different embodiments in the following sections further detail options for organizing the bitstream and the possible decoder structures.

At least one of the embodiments described involves normative modification of the codec.

In this section, three main embodiments are described in terms of framework. The first two consider codec structures which output images or video in the pixel (spatial) domain to be fed to task algorithms, whereas the last one reconstructs the pictures for viewing only.

Then, details are provided depending on specific autoencoders and the associated required syntax that such a standard for Video Coding for Machine (VCM) would require.

### Main Embodiments

Autoencoder Solution with Video as Output

### Single Synthesizer

A first embodiment has been illustrated in FIG. 1, where the decoder parameters are pre-defined, optimized either for viewing (video quality) or for multiple (machine) tasks at the same time with a composite loss. Then compression can be optimized for each task through the training of the encoder side analysis and optionally the corresponding machine task, while the parameters of the synthesis part are frozen. The main advantages are that the redundancies between the produced feature maps can be utilized for compression efficiency, while keeping a simple synthesis at the decoder which only requires one set of parameters. The standard decoder parses the bitstream and decodes the tensors corresponding to features maps which are to be fed to the same synthesizer. In the case of the single synthesizer, only the non-normative analysis part of the auto-encoder would be optimized.

Traditional video encoders are optimized for a specific application, e.g. broadcast, videoconferencing, video on demand . . . . For instance, videoconferencing H.265/HEVC encoders cannot implement all the prediction modes for encoding videos in real time on low end devices, whereas an Over-The-Top (OTT) provider can spend weeks to optimally encode movies. Both rely on the same standard decoder. To cope with different use cases with a single bitstream but different receivers, scalable coding was introduced.

In this case, the decoder can selectively decode the different layers, i.e. tensors of feature maps for each application. Note that the term “layer”, here, does not refer to the layers of a neural network, but the layers of tensors which compose the bitstream, like the layers of multi-view or scalable video coding.

### Multiple Synthesizers

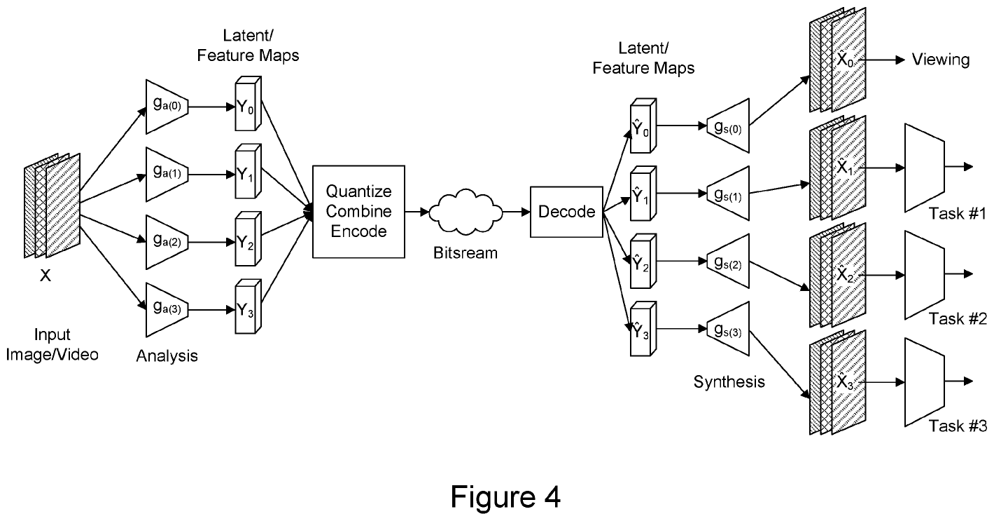

A second embodiment is shown in FIG. 4. The difference with the first method is that the synthesis at the decoder is also split, like the analysis at the decoder. In that case, each separate chain {analysis, synthesis, task algorithm} can be optimized with respect to each task. This requires the decoder to already know the parameters of the multiple tasks. Decoded syntax elements enable the mapping between the generated feature maps and the synthesizers. This method has the advantage of defining optimal chains {analysis, synthesis, task algorithm} whereas the first embodiment would always rely on a suboptimal synthesizer. However, the decoder needs to implement multiple models for synthesis and would be fixed with synthesizers for pre-defined tasks.

### Feeding Decoded Feature Maps to Task Algorithm

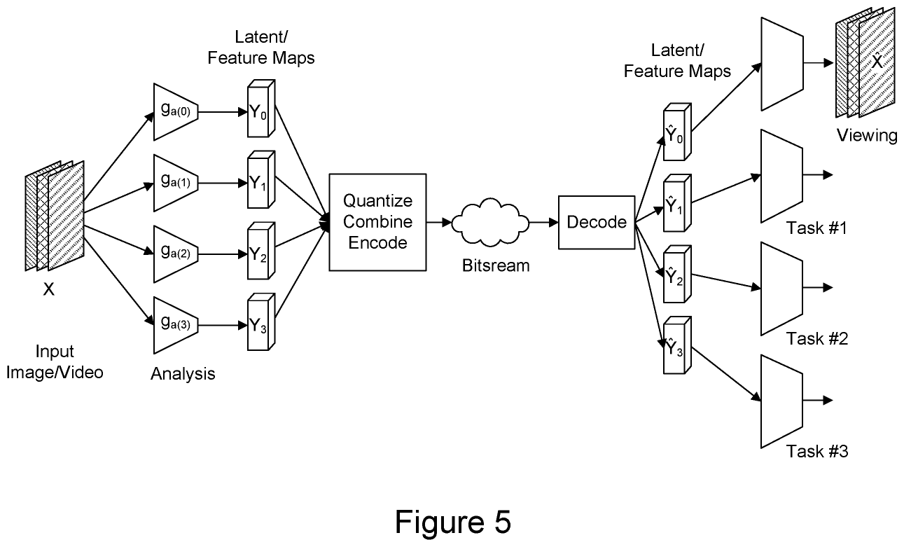

Most of the deep learning tasks take RGB (spatial domain) images as the input to the task model. However, recent works show that the reconstruction step can be skipped by retraining the task on feature maps directly. This way, faster inference can be expected with the time saved by not reconstructing the images/videos. FIG. 5 illustrates another proposed framework that goes in this direction. The synthesis block is only applied for the viewing task. For this to work, modified or novel task models need to be used for each task. Before end-to-end training, these modified/novel task models can be trained from scratch with latent/feature maps generated from a general encoder/analysis (Ex. gₐ(0)). Then end-to-end joint fine tuning can be performed starting from the above pre-trained task models.

### Predictive Coding

### Predictive Coding in Multi-Layer Compression Standards

In traditional video compression, and in particular in the case of scalable or multi-view (3D) video coding, compression efficiency relies on inter-layer prediction. In the case of Multiview coding for instance, instead of transmitting each video corresponding to each viewpoint, also called multi cast, further compression gains are reached by utilizing the redundancies between the frames captured by the different cameras. This requires aligning the images coming from different viewpoint, prior to computing the difference between the aligned images and extracting the residuals to be transmitted in the compressed bitstream. The decoder decodes the reference view first and then reconstruct a dependent side view by decoding the corresponding residuals which are then added to the aligned reference. The prediction between tensors can be performed directly, coefficient by coefficient, without any mapping or alignment prior to the extraction of residuals, assuming that the tensors have the same shape.

### Proposed Encoder/Decoder Processes

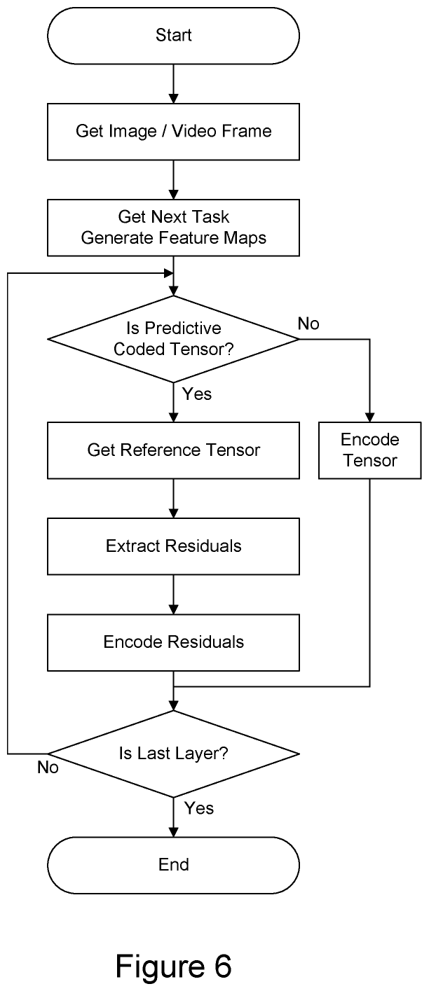

FIG. 5 and FIG. 6 describe the encoder and decoder processes, respectively. At the encoder, each new task is considered after fetching the source content, and the corresponding feature maps are generated (which corresponds to the function g a (i) described above). Then, if the current tensor corresponds to a “base layer”, it is quantized and encoded normally. Otherwise, the tensor is first predicted using an already encoded reference tensor. The latter is in the same state as if it were reconstructed at the decoder, i.e. quantized. The difference is computed, and residuals are then quantized and encoded.

At the decoder, reverse operations are performed. The layers are parsed from the bitstream, which contains syntax elements for mapping dependent tensors (see section on hyperprior-based models). If the layer is a key/base layer, it can be directly decoded. Otherwise, the residuals are decoded and the already decoded refence tensor is accessed to generate the decoded tensor by adding the residuals. Finally, the output frames are generated by the synthesizer gₛ or gₛ(i) in the case of multiple synthesizers.

### Syntax/Bitstream Structure

The method requires a syntax that refers to multi-layer coding. A base layer, e.g. the main chain optimized for viewing, can be decoded using the base autoencoder. Then the additional layers (i.e. tensors optimized for each tasks) require parameter sets that describe their ordering/mapping to specific tasks, as well as the dependencies between them for predictive coding.

For instance, one can think of a system where the base layer serves as reference for all the additional dependent layers. It can also be envisioned that some tasks are similar and result in feature maps that share more similarities and would benefit from predicted from each other.

All these combinations require syntax which include syntax elements for:
The number of layers (tensors related to given tasks) included in the bitstream
Dependency flags for each layer to point at the reference tensors
   It may also include additional information such as the size of the tensors if different from the base layer.

### Hyperprior-Based Models

Recent state-of-the-art methods compress images using a hyperprior (an additional auto encoder network operating on the generated latent by the base auto-encoder).

FIG. 5 illustrates the different blocks involved. The difference lies in the additional hyper analysis hₐ which generates a second latent, that will be then decoded by the hyper synthesis hₛ as parameters for a conditional distribution (for example mean and scale for a Gaussian distribution). The estimated distribution allows a more efficient entropy coding of the quantized (Q) tensor Y.

The produced hyperprior data Z at the encoder can also be combined with the Zᵢ for each task using predictive coding for instance. In the case of the single synthesizer, it appears relevant to use a single decoding hyperprior decoder hₛ too. In that case, either gₐ only or gₐ and hₐ can be jointly retrained for each task algorithm. In the other main embodiments multiple hyperprior, either a single hyper prior model or a hyperprior per latent can be considered.

The described embodiments can be applicable to ecosystems involving video coding and decoding, in particular when coupled with machine tasks, e.g. object detection, segmentation, etc. On-going activity at ISO/MPEG for a standard on Video Coding for Machines (VCM) provides potential implementation of these embodiments. The described embodiments and the associated syntax can be adopted in a future video compression standard. The decoder needs to be able to parse the bitstream containing the different parts related to each application.

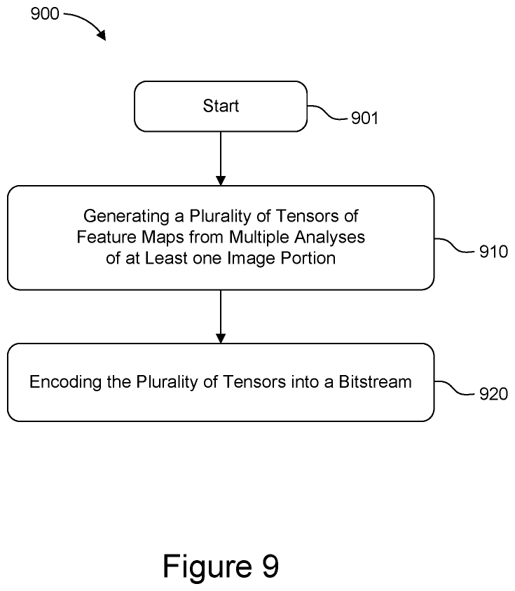

One embodiment of a method 900 under the general aspects described here is shown in FIG. 9. The method commences at start block 901 and control proceeds to block 910 for generating a plurality of tensors of feature maps from multiple analyses of at least one image portion. Control proceeds from block 910 to block 920 for encoding the plurality of tensors into a bitstream.

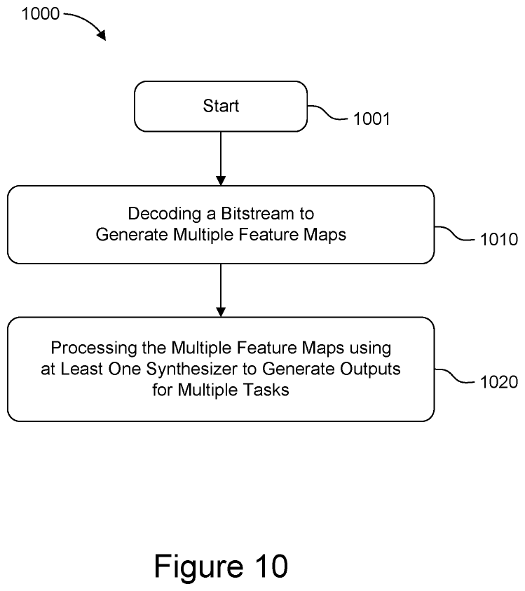

One embodiment of a method 1000 under the general aspects described here is shown in FIG. 10. The method commences at start block 1001 and control proceeds to block 1010 for decoding a bitstream to generate multiple feature maps. Control proceeds from block 1010 to block 1020 for processing the multiple feature maps using at least one synthesizer to generate outputs for multiple tasks.

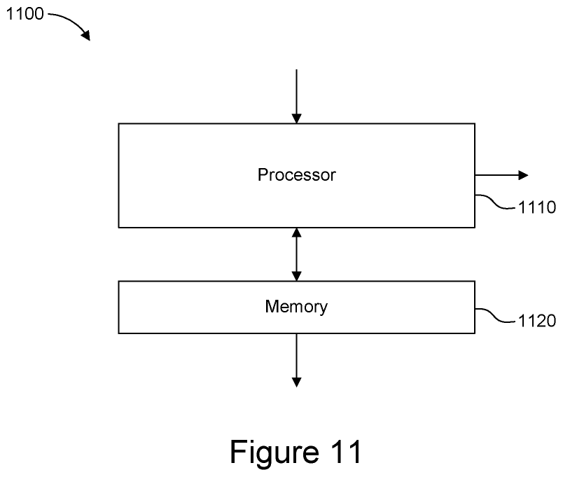

FIG. 11 shows one embodiment of an apparatus 1100 implementing the methods of FIG. 9 or FIG. 10. The apparatus comprises Processor 1110 and can be interconnected to a memory 1120 through at least one port. Both Processor 1110 and memory 1120 can also have one or more additional interconnections to external connections.

Processor 1110 is also configured to either insert or receive information in a bitstream and, either compressing, encoding, or decoding using any of the described aspects.

The embodiments described here include a variety of aspects, including tools, features, embodiments, models, approaches, etc. Many of these aspects are described with specificity and, at least to show the individual characteristics, are often described in a manner that may sound limiting. However, this is for purposes of clarity in description, and does not limit the application or scope of those aspects. Indeed, all of the different aspects can be combined and interchanged to provide further aspects. Moreover, the aspects can be combined and interchanged with aspects described in earlier filings as well.

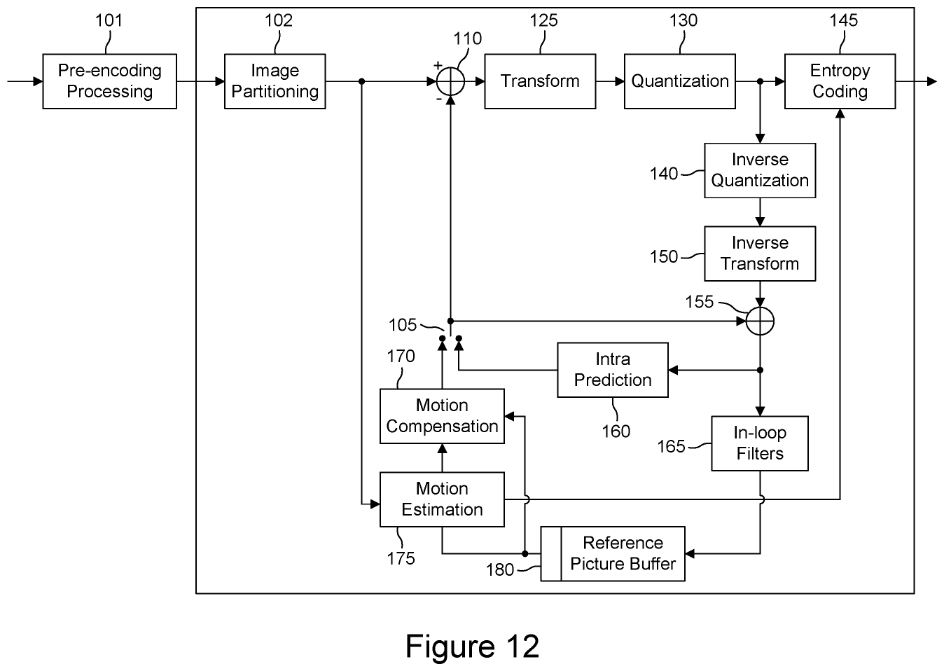

The aspects described and contemplated in this application can be implemented in many different forms. FIGS. 12, 13 and 14 provide some embodiments, but other embodiments are contemplated and the discussion of FIGS. 12, 13 and 14 does not limit the breadth of the implementations. At least one of the aspects generally relates to video encoding and decoding, and at least one other aspect generally relates to transmitting a bitstream generated or encoded. These and other aspects can be implemented as a method, an apparatus, a computer readable storage medium having stored thereon instructions for encoding or decoding video data according to any of the methods described, and/or a computer readable storage medium having stored thereon a bitstream generated according to any of the methods described.

In the present application, the terms “reconstructed” and “decoded” may be used interchangeably, the terms “pixel” and “sample” may be used interchangeably, the terms “image,” “picture” and “frame” may be used interchangeably. Usually, but not necessarily, the term “reconstructed” is used at the encoder side while “decoded” is used at the decoder side.

Various methods are described herein, and each of the methods comprises one or more steps or actions for achieving the described method. Unless a specific order of steps or actions is required for proper operation of the method, the order and/or use of specific steps and/or actions may be modified or combined.

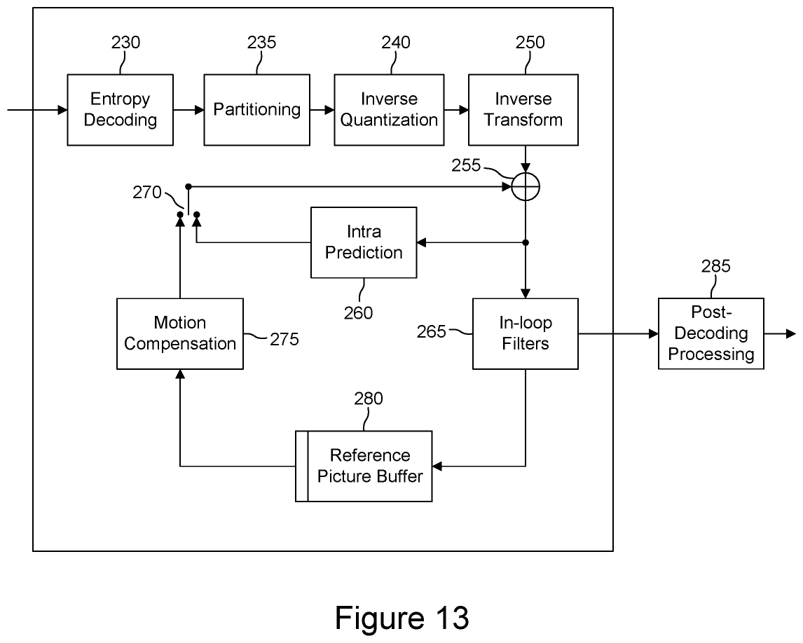

Various methods and other aspects described in this application can be used to modify modules, for example, the intra prediction, entropy coding, and/or decoding modules (160, 360, 145, 330), of a video encoder 100 and decoder 200 as shown in FIG. 12 and FIG. 13. Moreover, the present aspects are not limited to one particular standard, and can be applied, for example, to several standards and recommendations, whether pre-existing or future-developed, and extensions of any such standards and recommendations (including VVC and HEVC). Unless indicated otherwise, or technically precluded, the aspects described in this application can be used individually or in combination.

Various numeric values are used in the present application. The specific values are for example purposes and the aspects described are not limited to these specific values.

FIG. 12 illustrates an encoder 100. Variations of this encoder 100 are contemplated, but the encoder 100 is described below for purposes of clarity without describing all expected variations.

Before being encoded, the video sequence may go through pre-encoding processing (101), for example, applying a color transform to the input color picture (e.g., conversion from RGB 4:4:4 to YCbCr 4:2:0), or performing a remapping of the input picture components in order to get a signal distribution more resilient to compression (for instance using a histogram equalization of one of the color components). Metadata can be associated with the pre-processing and attached to the bitstream.

In the encoder 100, a picture is encoded by the encoder elements as described below. The picture to be encoded is partitioned (102) and processed in units of, for example, CUs. Each unit is encoded using, for example, either an intra or inter mode. When a unit is encoded in an intra mode, it performs intra prediction (160). In an inter mode, motion estimation (175) and compensation (170) are performed. The encoder decides (105) which one of the intra mode or inter mode to use for encoding the unit, and indicates the intra/inter decision by, for example, a prediction mode flag. Prediction residuals are calculated, for example, by subtracting (110) the predicted block from the original image block.

The prediction residuals are then transformed (125) and quantized (130). The quantized transform coefficients, as well as motion vectors and other syntax elements, are entropy coded (145) to output a bitstream. The encoder can skip the transform and apply quantization directly to the non-transformed residual signal. The encoder can bypass both transform and quantization, i.e., the residual is coded directly without the application of the transform or quantization processes.

The encoder decodes an encoded block to provide a reference for further predictions. The quantized transform coefficients are de-quantized (140) and inverse transformed (150) to decode prediction residuals. Combining (155) the decoded prediction residuals and the predicted block, an image block is reconstructed. In-loop filters (165) are applied to the reconstructed picture to perform, for example, deblocking/SAO (Sample Adaptive Offset) filtering to reduce encoding artifacts. The filtered image is stored at a reference picture buffer (180).

FIG. 13 illustrates a block diagram of a video decoder 200. In the decoder 200, a bitstream is decoded by the decoder elements as described below. Video decoder 200 generally performs a decoding pass reciprocal to the encoding pass as described in FIG. 12. The encoder 100 also generally performs video decoding as part of encoding video data.

In particular, the input of the decoder includes a video bitstream, which can be generated by video encoder 100. The bitstream is first entropy decoded (230) to obtain transform coefficients, motion vectors, and other coded information. The picture partition information indicates how the picture is partitioned. The decoder may therefore divide (235) the picture according to the decoded picture partitioning information. The transform coefficients are de-quantized (240) and inverse transformed (250) to decode the prediction residuals. Combining (255) the decoded prediction residuals and the predicted block, an image block is reconstructed. The predicted block can be obtained (270) from intra prediction (260) or motion-compensated prediction (i.e., inter prediction) (275). In-loop filters (265) are applied to the reconstructed image. The filtered image is stored at a reference picture buffer (280).

The decoded picture can further go through post-decoding processing (285), for example, an inverse color transform (e.g. conversion from YcbCr 4:2:0 to RGB 4:4:4) or an inverse remapping performing the inverse of the remapping process performed in the pre-encoding processing (101). The post-decoding processing can use metadata derived in the pre-encoding processing and signaled in the bitstream.

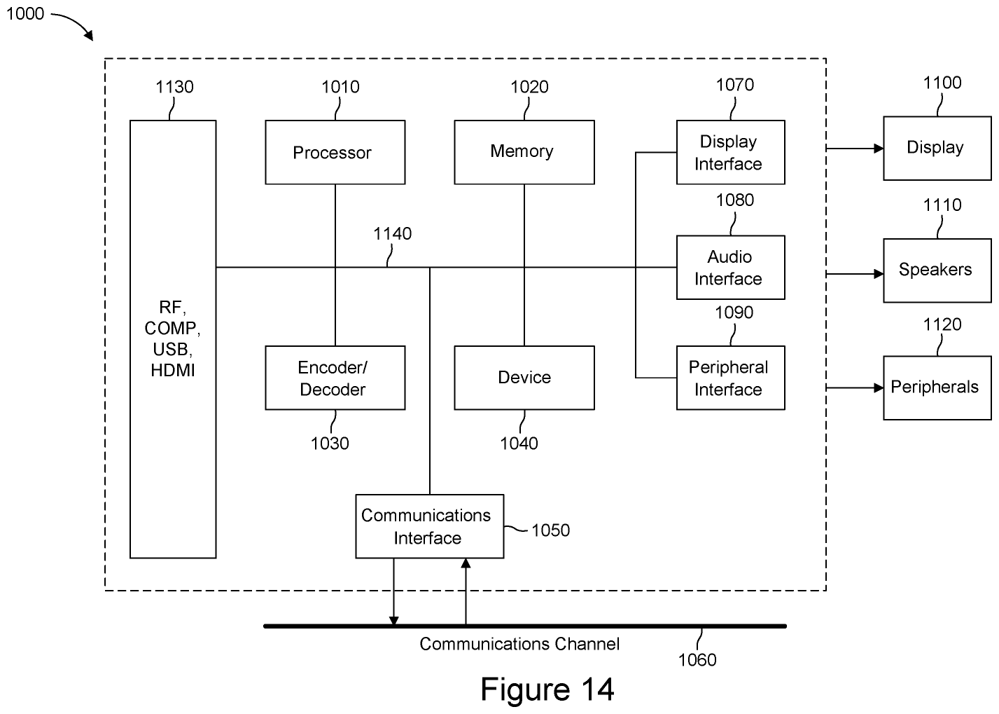

FIG. 14 illustrates a block diagram of an example of a system in which various aspects and embodiments are implemented. System 1000 can be embodied as a device including the various components described below and is configured to perform one or more of the aspects described in this document. Examples of such devices include, but are not limited to, various electronic devices such as personal computers, laptop computers, smartphones, tablet computers, digital multimedia set top boxes, digital television receivers, personal video recording systems, connected home appliances, and servers. Elements of system 1000, singly or in combination, can be embodied in a single integrated circuit (IC), multiple ICs, and/or discrete components. For example, in at least one embodiment, the processing and encoder/decoder elements of system 1000 are distributed across multiple ICs and/or discrete components. In various embodiments, the system 1000 is communicatively coupled to one or more other systems, or other electronic devices, via, for example, a communications bus or through dedicated input and/or output ports. In various embodiments, the system 1000 is configured to implement one or more of the aspects described in this document.

The system 1000 includes at least one processor 1010 configured to execute instructions loaded therein for implementing, for example, the various aspects described in this document. Processor 1010 can include embedded memory, input output interface, and various other circuitries as known in the art. The system 1000 includes at least one memory 1020 (e.g., a volatile memory device, and/or a non-volatile memory device). System 1000 includes a storage device 1040, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive. The storage device 1040 can include an internal storage device, an attached storage device (including detachable and non-detachable storage devices), and/or a network accessible storage device, as non-limiting examples.

System 1000 includes an encoder/decoder module 1030 configured, for example, to process data to provide an encoded video or decoded video, and the encoder/decoder module 1030 can include its own processor and memory. The encoder/decoder module 1030 represents module(s) that can be included in a device to perform the encoding and/or decoding functions. As is known, a device can include one or both of the encoding and decoding modules. Additionally, encoder/decoder module 1030 can be implemented as a separate element of system 1000 or can be incorporated within processor 1010 as a combination of hardware and software as known to those skilled in the art.

Program code to be loaded onto processor 1010 or encoder/decoder 1030 to perform the various aspects described in this document can be stored in storage device 1040 and subsequently loaded onto memory 1020 for execution by processor 1010. In accordance with various embodiments, one or more of processor 1010, memory 1020, storage device 1040, and encoder/decoder module 1030 can store one or more of various items during the performance of the processes described in this document. Such stored items can include, but are not limited to, the input video, the decoded video or portions of the decoded video, the bitstream, matrices, variables, and intermediate or final results from the processing of equations, formulas, operations, and operational logic.

In some embodiments, memory inside of the processor 1010 and/or the encoder/decoder module 1030 is used to store instructions and to provide working memory for processing that is needed during encoding or decoding. In other embodiments, however, a memory external to the processing device (for example, the processing device can be either the processor 1010 or the encoder/decoder module 1030) is used for one or more of these functions. The external memory can be the memory 1020 and/or the storage device 1040, for example, a dynamic volatile memory and/or a non-volatile flash memory. In several embodiments, an external non-volatile flash memory is used to store the operating system of, for example, a television. In at least one embodiment, a fast external dynamic volatile memory such as a RAM is used as working memory for video coding and decoding operations, such as for MPEG-2 (MPEG refers to the Moving Picture Experts Group, MPEG-2 is also referred to as ISO/IEC 13818, and 13818-1 is also known as H.222, and 13818-2 is also known as H.262), HEVC (HEVC refers to High Efficiency Video Coding, also known as H.265 and MPEG-H Part 2), or VVC (Versatile Video Coding, a new standard being developed by JVET, the Joint Video Experts Team).

The input to the elements of system 1000 can be provided through various input devices as indicated in block 1130. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High Definition Multimedia Interface (HDMI) input terminal. Other examples, not shown in FIG. 14, include composite video.

In various embodiments, the input devices of block 1130 have associated respective input processing elements as known in the art. For example, the RF portion can be associated with elements suitable for (i) selecting a desired frequency (also referred to as selecting a signal, or band-limiting a signal to a band of frequencies), (ii) downconverting the selected signal, (iii) band-limiting again to a narrower band of frequencies to select (for example) a signal frequency band which can be referred to as a channel in certain embodiments, (iv) demodulating the downconverted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, downconverting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, downconverting, and filtering again to a desired frequency band. Various embodiments rearrange the order of the above-described (and other) elements, remove some of these elements, and/or add other elements performing similar or different functions. Adding elements can include inserting elements in between existing elements, such as, for example, inserting amplifiers and an analog-to-digital converter. In various embodiments, the RF portion includes an antenna.

Additionally, the USB and/or HDMI terminals can include respective interface processors for connecting system 1000 to other electronic devices across USB and/or HDMI connections. It is to be understood that various aspects of input processing, for example, Reed-Solomon error correction, can be implemented, for example, within a separate input processing IC or within processor 1010 as necessary. Similarly, aspects of USB or HDMI interface processing can be implemented within separate interface Ics or within processor 1010 as necessary. The demodulated, error corrected, and demultiplexed stream is provided to various processing elements, including, for example, processor 1010, and encoder/decoder 1030 operating in combination with the memory and storage elements to process the datastream as necessary for presentation on an output device.

Various elements of system 1000 can be provided within an integrated housing, Within the integrated housing, the various elements can be interconnected and transmit data therebetween using suitable connection arrangement, for example, an internal bus as known in the art, including the Inter-IC (I2C) bus, wiring, and printed circuit boards.

The system 1000 includes communication interface 1050 that enables communication with other devices via communication channel 1060. The communication interface 1050 can include, but is not limited to, a transceiver configured to transmit and to receive data over communication channel 1060. The communication interface 1050 can include, but is not limited to, a modem or network card and the communication channel 1060 can be implemented, for example, within a wired and/or a wireless medium.

Data is streamed, or otherwise provided, to the system 1000, in various embodiments, using a wireless network such as a Wi-Fi network, for example IEEE 802.11 (IEEE refers to the Institute of Electrical and Electronics Engineers). The Wi-Fi signal of these embodiments is received over the communications channel 1060 and the communications interface 1050 which are adapted for Wi-Fi communications. The communications channel 1060 of these embodiments is typically connected to an access point or router that provides access to external networks including the Internet for allowing streaming applications and other over-the-top communications. Other embodiments provide streamed data to the system 1000 using a set-top box that delivers the data over the HDMI connection of the input block 1130. Still other embodiments provide streamed data to the system 1000 using the RF connection of the input block 1130. As indicated above, various embodiments provide data in a non-streaming manner. Additionally, various embodiments use wireless networks other than Wi-Fi, for example a cellular network or a Bluetooth network.

The system 1000 can provide an output signal to various output devices, including a display 1100, speakers 1110, and other peripheral devices 1120. The display 1100 of various embodiments includes one or more of, for example, a touchscreen display, an organic light-emitting diode (OLED) display, a curved display, and/or a foldable display. The display 1100 can be for a television, a tablet, a laptop, a cell phone (mobile phone), or another device. The display 1100 can also be integrated with other components (for example, as in a smart phone), or separate (for example, an external monitor fora laptop). The other peripheral devices 1120 include, in various examples of embodiments, one or more of a stand-alone digital video disc (or digital versatile disc) (DVR, for both terms), a disk player, a stereo system, and/or a lighting system. Various embodiments use one or more peripheral devices 1120 that provide a function based on the output of the system 1000. For example, a disk player performs the function of playing the output of the system 1000.

In various embodiments, control signals are communicated between the system 1000 and the display 1100, speakers 1110, or other peripheral devices 1120 using signaling such as AV.Link, Consumer Electronics Control (CEC), or other communications protocols that enable device-to-device control with or without user intervention. The output devices can be communicatively coupled to system 1000 via dedicated connections through respective interfaces 1070, 1080, and 1090. Alternatively, the output devices can be connected to system 1000 using the communications channel 1060 via the communications interface 1050. The display 1100 and speakers 1110 can be integrated in a single unit with the other components of system 1000 in an electronic device such as, for example, a television. In various embodiments, the display interface 1070 includes a display driver, such as, for example, a timing controller (T Con) chip.

The display 1100 and speaker 1110 can alternatively be separate from one or more of the other components, for example, if the RF portion of input 1130 is part of a separate set-top box. In various embodiments in which the display 1100 and speakers 1110 are external components, the output signal can be provided via dedicated output connections, including, for example, HDMI ports, USB ports, or COMP outputs.

The embodiments can be carried out by computer software implemented by the processor 1010 or by hardware, or by a combination of hardware and software. As a non-limiting example, the embodiments can be implemented by one or more integrated circuits. The memory 1020 can be of any type appropriate to the technical environment and can be implemented using any appropriate data storage technology, such as optical memory devices, magnetic memory devices, semiconductor-based memory devices, fixed memory, and removable memory, as non-limiting examples. The processor 1010 can be of any type appropriate to the technical environment, and can encompass one or more of microprocessors, general purpose computers, special purpose computers, and processors based on a multi-core architecture, as non-limiting examples.

Various implementations involve decoding. “Decoding”, as used in this application, can encompass all or part of the processes performed, for example, on a received encoded sequence to produce a final output suitable for display. In various embodiments, such processes include one or more of the processes typically performed by a decoder, for example, entropy decoding, inverse quantization, inverse transformation, and differential decoding. In various embodiments, such processes also, or alternatively, include processes performed by a decoder of various implementations described in this application.

As further examples, in one embodiment “decoding” refers only to entropy decoding, in another embodiment “decoding” refers only to differential decoding, and in another embodiment “decoding” refers to a combination of entropy decoding and differential decoding. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application can encompass all or part of the processes performed, for example, on an input video sequence to produce an encoded bitstream. In various embodiments, such processes include one or more of the processes typically performed by an encoder, for example, partitioning, differential encoding, transformation, quantization, and entropy encoding. In various embodiments, such processes also, or alternatively, include processes performed by an encoder of various implementations described in this application.

As further examples, in one embodiment “encoding” refers only to entropy encoding, in another embodiment “encoding” refers only to differential encoding, and in another embodiment “encoding” refers to a combination of differential encoding and entropy encoding. Whether the phrase “encoding process” is intended to refer specifically to a subset of operations or generally to the broader encoding process will be clear based on the context of the specific descriptions and is believed to be well understood by those skilled in the art.

Note that the syntax elements as used herein are descriptive terms. As such, they do not preclude the use of other syntax element names.

When a figure is presented as a flow diagram, it should be understood that it also provides a block diagram of a corresponding apparatus. Similarly, when a figure is presented as a block diagram, it should be understood that it also provides a flow diagram of a corresponding method/process.

Various embodiments may refer to parametric models or rate distortion optimization. In particular, during the encoding process, the balance or trade-off between the rate and distortion is usually considered, often given the constraints of computational complexity. It can be measured through a Rate Distortion Optimization (RDO) metric, or through Least Mean Square (LMS), Mean of Absolute Errors (MAE), or other such measurements. Rate distortion optimization is usually formulated as minimizing a rate distortion function, which is a weighted sum of the rate and of the distortion. There are different approaches to solve the rate distortion optimization problem. For example, the approaches may be based on an extensive testing of all encoding options, including all considered modes or coding parameters values, with a complete evaluation of their coding cost and related distortion of the reconstructed signal after coding and decoding. Faster approaches may also be used, to save encoding complexity, in particular with computation of an approximated distortion based on the prediction or the prediction residual signal, not the reconstructed one. Mix of these two approaches can also be used, such as by using an approximated distortion for only some of the possible encoding options, and a complete distortion for other encoding options. Other approaches only evaluate a subset of the possible encoding options. More generally, many approaches employ any of a variety of techniques to perform the optimization, but the optimization is not necessarily a complete evaluation of both the coding cost and related distortion.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented in, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information can include one or more of, for example, estimating the information, calculating the information, predicting the information, or retrieving the information from memory.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. For example, in certain embodiments the encoder signals a particular one of a plurality of transforms, coding modes or flags. In this way, in an embodiment the same transform, parameter, or mode is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual functions, a bit savings is realized in various embodiments. It is to be appreciated that signaling can be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

As will be evident to one of ordinary skill in the art, implementations can produce a variety of signals formatted to carry information that can be, for example, stored or transmitted. The information can include, for example, instructions for performing a method, or data produced by one of the described implementations. For example, a signal can be formatted to carry the bitstream of a described embodiment. Such a signal can be formatted, for example, as an electromagnetic wave (for example, using a radio frequency portion of spectrum) or as a baseband signal. The formatting can include, for example, encoding a data stream and modulating a carrier with the encoded data stream. The information that the signal carries can be, for example, analog or digital information. The signal can be transmitted over a variety of different wired or wireless links, as is known. The signal can be stored on a processor-readable medium.

The preceding sections describe a number of embodiments, across various claim categories and types. Features of these embodiments can be provided alone or in any combination. Further, embodiments can include one or more of the following features, devices, or aspects, alone or in any combination, across various claim categories and types:
Generating a plurality of tensors of feature maps from multiple analyses of at least one image portion, image or video sequence; and encoding said plurality of tensors into a bitstream.
Decoding a bitstream to generate multiple feature maps; and processing the multiple feature maps using at least one synthesizer to generate outputs for multiple tasks.
Either of the above embodiments with syntax representing number of layers in the bitstream.
Either of the above embodiments with syntax representing dependency flags for each layer to point at reference tensors.
A bitstream or signal that includes one or more of the described syntax elements, or variations thereof.
A bitstream or signal that includes syntax conveying information generated according to any of the embodiments described.
Creating and/or transmitting and/or receiving and/or decoding according to any of the embodiments described.
A method, process, apparatus, medium storing instructions, medium storing data, or signal according to any of the embodiments described.
Inserting in the signaling syntax elements that enable the decoder to determine decoding information in a manner corresponding to that used by an encoder.
Creating and/or transmitting and/or receiving and/or decoding a bitstream or signal that includes one or more of the described syntax elements, or variations thereof.
A TV, set-top box, cell phone, tablet, or other electronic device that performs transform method(s) according to any of the embodiments described.
A TV, set-top box, cell phone, tablet, or other electronic device that performs transform method(s) determination according to any of the embodiments described, and that displays (e.g. using a monitor, screen, or other type of display) a resulting image.
A TV, set-top box, cell phone, tablet, or other electronic device that selects, bandlimits, or tunes (e.g. using a tuner) a channel to receive a signal including an encoded image, and performs transform method(s) according to any of the embodiments described.
A TV, set-top box, cell phone, tablet, or other electronic device that receives (e.g. using an antenna) a signal over the air that includes an encoded image, and performs transform method(s).

1. A method, comprising:
generating a plurality of tensors of feature maps from multiple analyses of at least one image portion; and
encoding said plurality of tensors into a bitstream, wherein said bitstream comprises a number of layers in the bitstream or dependency flags for layers to point at reference tensors.

2. An apparatus, comprising:
a processor, configured to:
generate a plurality of tensors of feature maps from multiple analyses of at least one image portion; and
encode said plurality of tensors into a bitstream, wherein said bitstream comprises a number of layers in the bitstream or dependency flags for layers to point at reference tensors.

3. A method, comprising:
decoding a bitstream to generate multiple feature maps, wherein said bitstream comprises a number of layers in the bitstream or dependency flags for layers to point at reference tensors; and
processing the multiple feature maps using at least one synthesizer to generate outputs for multiple tasks.

4. An apparatus, comprising:
a processor, configured to:
decode a bitstream to generate multiple feature maps, wherein said bitstream comprises a number of layers in the bitstream or dependency flags for layers to point at reference tensors; and
process the multiple feature maps using at least one synthesizer to generate outputs for multiple tasks.

5. The method of claim 1, wherein each tensor of feature maps is input to a different synthesis stage, for performing a given task.

6. The method of claim 5, wherein said different synthesis stages are optimized for said given task.

7. The apparatus of claim 2, wherein tensors are compressed using predictive coding.

8. The apparatus of claim 7, wherein predictive coding comprises transmitting encoded residuals between different tensors.

9. The method of claim 3, wherein one synthesizer is used for a viewing task.

10. The apparatus of claim 2, wherein said bitstream comprises multi-view video coding.

11. (canceled)

12. A device comprising:
an apparatus according to claim 2; and
at least one of (i) an antenna configured to receive a signal, the signal including the video block, (ii) a band limiter configured to limit the received signal to a band of frequencies that includes the video block, and (iii) a display configured to display an output representative of a video block.

13. A non-transitory computer readable medium containing data content generated according to claim 1, for playback using a processor.

14. (canceled)

15. A computer program product comprising instructions which, when the program is executed by a computer, cause the computer to carry out the method of claim 3.

16. The method of claim 3, wherein each tensor of feature maps is input to a different synthesis stage, for performing a given task.

17. The method of claim 5, wherein said different synthesis stages are optimized for said given task.

18. The apparatus of claim 4, wherein tensors are compressed using predictive coding.

19. The apparatus of claim 7, wherein predictive coding comprises transmitting encoded residuals between different tensors.

20. The apparatus of claim 4, wherein one synthesizer is used for a viewing task.

21. The apparatus of claim 4, wherein said bitstream comprises multi-view video coding.
